(19) United States
(12) Patent Application Publication
(10) Pub. No.: US 2021/0049941 A1
(43) Pub. Date: Feb. 18, 2021

(54) METHOD FOR MOUNTING A FLEXIBLE COVERING STRETCHED OVER A SECURING FRAME, AND SECURING FRAME FOR CARRYING OUT SUCH A METHOD

(71) Applicant: CLIPSO PRODUCTIONS, Vieux-Thann (FR)

(72) Inventor: Bernard GEIS, Chavannes Pres Renens (CH)

(21) Appl. No.: 16/969,371

(22) PCT Filed: Mar. 5, 2019
(86) PCT No.: PCT/FR2019/000029

§ 371 Date: Aug. 12, 2020

(30) Foreign Application Priority Data
Mar. 7, 2018 (FR) 1851946

(51) Int. Cl. G09F 15/00

(52) U.S. Cl. CPC G09F 15/0012; G09F 2007/1843; G09F 15/0018

(57) ABSTRACT

A fixing frame (10) allowing easy and quick assembly and disassembly of a stretched flexible covering, in particular a textile frame for an advertising medium. The frame comprises an assembly of rigid base profiles (11) and flexible holding profiles (31), fitted onto the base profiles (11), to create an attached but removable clamping system (30). The base channel (11) has a first parallel groove (16) and a second groove (17), and the support profile (31) has a first wing (32) and a second wing (33) extending into two directions. The first wing (32) cooperates with the first groove (16) to form the clamping system (30), and the second wing (33) is fitted into the second groove (17) of the base section (11) to create a fixed but removable connection of the holding profile (17).

### TECHNICAL FIELD

The present invention relates to a method for mounting a tensioned flexible canvas on a fixing frame, said fixing frame comprising an assembly of rigid base profiles, each base profile comprising a first longitudinal groove constituting a receiving housing for a peripheral edge of said covering.

The invention also relates to a fixing frame for implementing said mounting method, said fixing frame comprising an assembly of rigid base profiles, each base profile comprising a first groove constituting a receiving housing for a peripheral edge of said covering.

### PRIOR ART

The invention is particularly related, but not exclusively, to the field of visual communication via advertising panels, promotional media, etc. in the form of tensioned textile frames ideally used for fairs, exhibitions, shop windows, professional premises and offices, etc. These tensioned textile frames are commonly manufactured from printed canvas, provided on their periphery with a sewn silicone joint. The frames are manufactured by assembling aluminum profiles, provided with a U-shaped groove adapted to receive by fitting the silicone joint of the printed canvas and to hold it by pinching.

In this way, the printed canvas is fastened and tensioned to the frame by means of a force fit of the silicone seal in the groove. This assembly has the advantage of being able to be carried out manually and without tools, by an unskilled person safely. In order to dismount the canvas, a tab is used which is provided on one of the sides of the canvas, which is accessible from outside the frame and allows the tab to be pulled out of the groove by simple manual pulling. This mounting and dismounting technique is very convenient to use, accessible to any person, without danger, and makes it possible to easily and quickly replace the printed canvas to change and update the communication visuals.

However, the manufacture of the printed canvas for this type of application is constraining for several reasons. The dimensions of the canvas are strictly imposed by the dimensions of the frames, they must be tailor-made and must further meet precise manufacturing tolerances. After manufacturing, they must be customized to add a silicone seal along the peripheral edge of the web, generally through a sewing operation that is delicate to perform and time consuming.

This known technique is therefore not entirely satisfactory.

Document WO 2013/079956 proposes to implement a clamp on a frame in order to block and stretch a sheet of material on the frame. To this end, in this document, the sheet comprises a single stiffened edge, for example by attaching a silicone seal thereto. The clamp is mounted on a first wall of the frame by clipping: the clamp comprises two wings which clamp the first wall of the frame. The clip has projections projecting from one of the wings, which abut against a second wall of the frame, parallel to the first wall. The liner is then inserted between the projections and the second wall of the frame.

The method described in this document therefore has the above-mentioned drawbacks, since at least one edge is to be stiffened.

Furthermore, the removal of the clamp proves to be a delicate operation. In fact, the liner must be removed beforehand by exerting a force thereon in order to release the projections, at risk of damaging it. Then only secondly, the clamp can be removed.

### SUMMARY OF THE INVENTION

The present invention aims in particular to overcome these disadvantages by providing a mounting method as well as a suitable fixing frame making it possible to simplify the manufacture of the flexible canvas, while retaining the same advantages related to the ease and rapidity of mounting and dismounting said canvas on said fixing frame, enabling quick change of the visualizations, easy handling for any unskilled person, easy and secure use, without deterioration of said canvas which can be reused.

For this purpose, the invention relates to a mounting method of the type indicated in the preamble, characterized in that, prior to mounting said canvas on said fixing frame, a clamping system is added to each base profile. The clamping system is inserted under compressive constraint between an outer limb and the inner limb of the base profile. Said clamping system is arranged to retain at least one peripheral edge of the liner in said receiving housing. In addition, the pinching system is removable and comprises at least one separate and separate part of said base profiles and said covering. Furthermore, in order to mount said covering on said fixing frame, the peripheral edge of said covering is introduced into said receiving housing against the compression of said clamping system by using an insertion tool.

The compression clamping system thus allows, by the only restoring force, both to be held on a base profile and to hold an edge of the lining in the receiving housing. The installation and removal of the liner and the pinching system are simplified, and the risk of damaging the liner or the pinching system is reduced.

According to one embodiment, in order to produce said clamping system, holding profiles are used. Each holding profile comprises a first wing and a second wing extending in two mutually parallel directions, the first wing of the holding profile coming into contact with the outer branch of the base profile and the second wing of the holding profile coming into contact with the inner branch of the base profile.

In one embodiment of the invention, in order to produce said pinching system, flexible holding profiles are used, and at least one holding profile is fitted onto each base profile, said holding profile comprising at least one first wing which is inserted under constraint into said receiving housing so that it cooperates with a fixed branch of said base profile and forms therewith said pinching system.

Advantageously, use is made of a base profile provided with a second longitudinal groove extending in a direction parallel to that of the first groove, as well as a holding profile comprising a first wing and a second wing extending in two mutually parallel directions, the first wing cooperating with said first groove to form said pinching system, and the second wing being nested in said second groove of said base profile to create a fixed and dismountable connection of said holding profile. A holding profile having a V-Shaped or U-shaped cross-section is preferably used.

It is also possible to provide on said flexible canvas, a projecting tab on at least one of its peripheral edges, said tab being arranged to remain accessible outside said fixing frame after said covering is mounted, and to dismantle said canvas of said fixing frame, said tab is advantageously pulled to extract said corresponding peripheral edge of said base profile, carrying with it said corresponding holding profile which is removed, thanks in particular to the return force of the compression clamping system, of said base profile and enables said covering to be removed.

In one embodiment, the canvas is devoid of stiffened edge.

In order to create an autonomous, self-supporting fastening frame, said base profiles can be joined together, or can be joined end-to-end to a specific frame.

In order to create a fastening frame which is superimposed on a support wall, each base profile can be joined end-to-end on the support wall.

The invention also relates to a fixing frame of the type indicated in the preamble, characterized in that it further comprises a clamping system directly mounted on each base profile. The pinching system is arranged to be inserted under compression constraint between an outer branch and an inner branch of the base profile and is arranged to retain said peripheral edge in said reception housing when said canvas is mounted. Said pinching system is removable and comprises at least one different and separate part of said base profiles and said canvas.

In a preferred embodiment of the invention, said pinching system comprises flexible holding profiles, at least one holding profile being fitted on each base profile, said holding profile comprising at least one first wing inserted under constraint into said receiving housing so that it cooperates with a fixed branch of said base profile and forms therewith said pinching system.

Said base profile advantageously comprises a second longitudinal groove extending in a direction parallel to that of the first groove, and said holding profile advantageously comprises a first wing and a second wing extending in two mutually parallel directions, the first wing cooperating with said first groove to form said pinching system, and the second wing being nested in said second groove of said base profile to create a fixed and dismountable connection of said holding profile.

In the preferred embodiment of the invention, the holding profile has a V-Shaped or U-shaped cross-section.

Still in the preferred form of the invention, the first groove and the second groove of said base profile are parallel. The second groove of said base profile may have a depth less than that of the first groove, and a width less than that of the first groove.

According to the foreseen application, the fixing frame may comprise an assembly device arranged to assemble said base profiles together and create an autonomous and self-supporting fixing frame. The base profiles may further include a longitudinally extending lug for attachment to a support wall or a specific frame.

### BRIEF DESCRIPTION OF THE DRAWINGS

The present invention and its advantages will appear more clearly in the following description of several embodiments given as non-limiting examples, with reference to the appended drawings, in which:

FIG. 1 is a perspective view of an example of a self-supporting fixing frame according to the invention,

FIG. 2 is a section of a base profile, being part of the manufacture of the frame of FIG. 1,

FIG. 3 is a perspective view of a holding profile, being part the manufacture of the frame of FIG. 1,

FIG. 4 is a perspective view of the base profile of FIG. 2 fixed to a wall,

FIG. 5 is a sectional view of a fixing frame mounted on a wall, showing the installation of a flexible canvas, and

FIG. 6 is an enlarged view of detail A of FIG. 5 showing the maintenance of said flexible canvas in said fixing frame.

### ILLUSTRATIONS OF THE INVENTION AND VARIOUS WAYS OF MAKING IT

In the illustrated embodiments, the identical elements or portions have the same reference numbers.

With reference to the figures, the invention relates to a fixing frame 10 for mounting and dismounting a flexible canvas 1 stretched on said frame, to create in particular but not exclusively an advertising panel, a promotional support, or the like, used in visual communication, decoration, etc. for example in fairs, exhibitions, shop windows, professional premises and professional premises, private premises, etc. The invention is of course not limited to this application, and extends to the creation of atmosphere boxes, false wall slabs, false ceilings, double wall walls, partition panels, or the like.

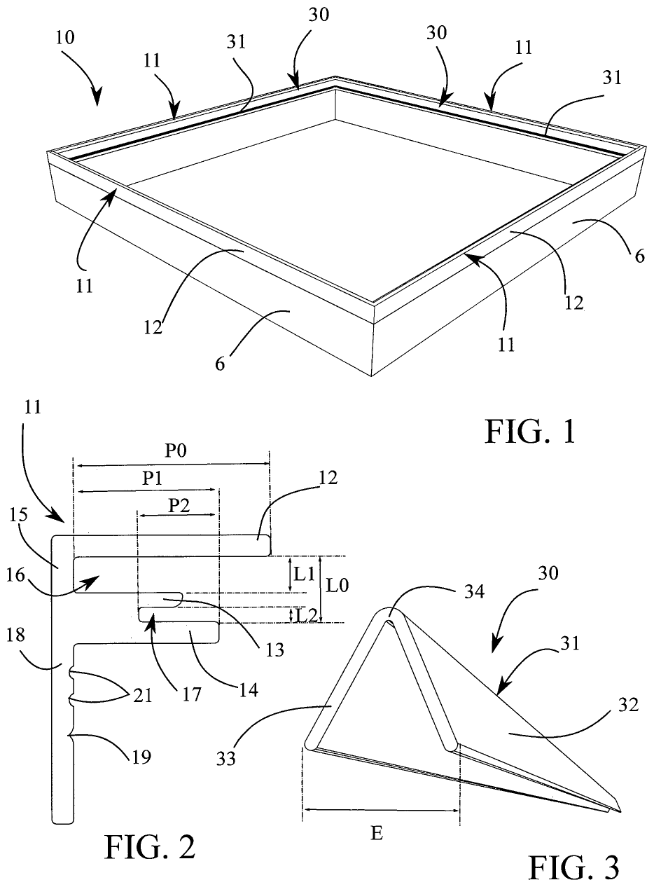

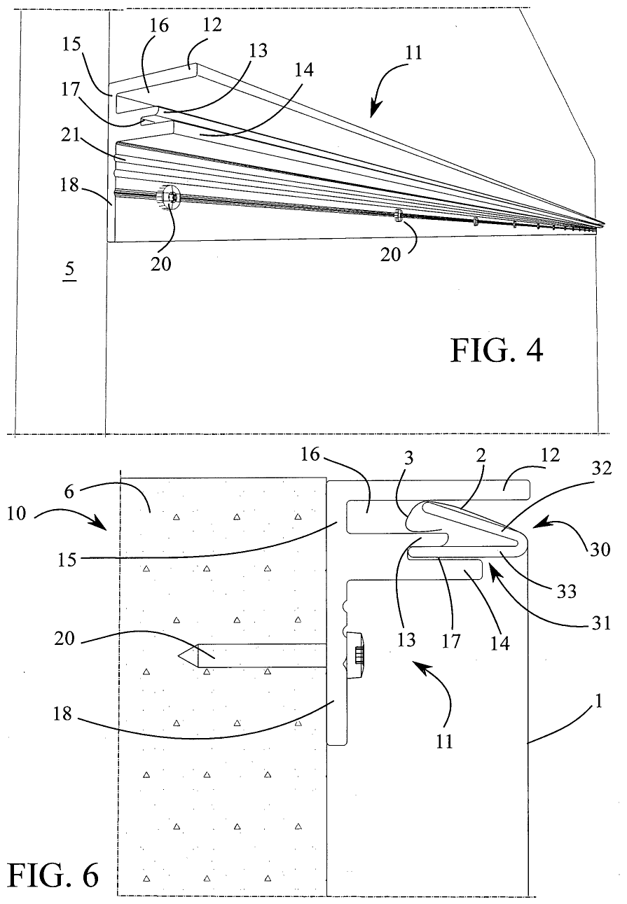

FIG. 1 illustrates an example of use of a fixing frame 10 in autonomous and self-supporting mode, which can be placed, suspended, or hooked onto any type of support, and FIG. 4 illustrates an example of use of a fixing frame 10, only one side of which is shown, in fixed mode on a support wall 5, such as a wall, a ceiling or the like. To achieve these various implementations, base profiles 11 are used which are assembled to form a fixing frame 10, by fixing them on a support wall 5 (FIG. 4) or on a frame 6 (FIG. 1) end to end to cover the perimeter of the wall or frame to be covered, or by fixing them together end to end to create a self-supporting fixing frame 10. FIG. 1 illustrates a so-called self-supporting fixing frame 10 as it is not connected to any fixed wall. However, it is carried by a frame 6 which provides greater rigidity to said frame. In this case, the frame 6 can be made of any compatible material, such as wooden beams, compressed wood particles, synthetic materials, composite materials, etc., allowing the base profiles 11 to be fixed in particular by screwing the base profiles 11. These examples are of course non-limiting. In fact, the base profiles 11 can have an enlarged section integrating a base or the like, making it possible to dispense with the frame 6 and form themselves a self-supporting fixing frame 10. In this case, the base profiles 11 are assembled together either by complementary fitting shapes provided at their ends, or by assembly parts inserted into the corners, such as angle brackets, for example.

The flexible canvas 1 may be any material compatible with the use, such as a coated or uncoated woven fabric, a coated or non-coated nonwoven web, a plastic or composite film, etc. The canvas 1 is manufactured or cut in a format taking into account the dimensions of the fixing frame 10 so that its peripheral edges 2 protrude sufficiently from said frame so that they can be introduced inside the base profiles 11 by still having a surplus 3 of canvas inside said base profiles 11 (see FIG. 6). Thus, according to the mounting method of the invention, the format of the canvas 1 does not need to comply with strict and stringent tolerances. The canvas 1 is further devoid of stiffened edges, reducing the manufacturing costs of the canvas 1.

In fact, the mounting method of the invention is innovative and is different from known mounting methods, in that the fixing frame 10 comprises a removable clamping system 30 which makes it possible to keep the canvas 1 under tension, but which is neither integral with the base profiles 11, nor integral with the peripheral edges 2 of said canvas 1. This pinching system 30 is obtained in particular by additional holding profiles 31, which are added to the base profiles 11 before the canvas 1 is mounted. They are removable with respect to the base profiles 11 and thus make it possible to facilitate the assembly and disassembly of the canvas 1, without any technical difficulty, and without danger, these operations being able to be carried out by any person, without particular skills.

The base profile 11 used in the invention is illustrated more particularly in FIGS. 2 and 4 to 6. It is produced from an elongated piece, straight and rigid material, preferably obtained by extrusion of a metal material, such as, for example, aluminum or any other light metal alloy, but also a reinforced synthetic material, a composite material or a combination of these materials, the material used preferably being non-corrosive and the resulting profile preferably offering good flexural strength under normal use conditions.

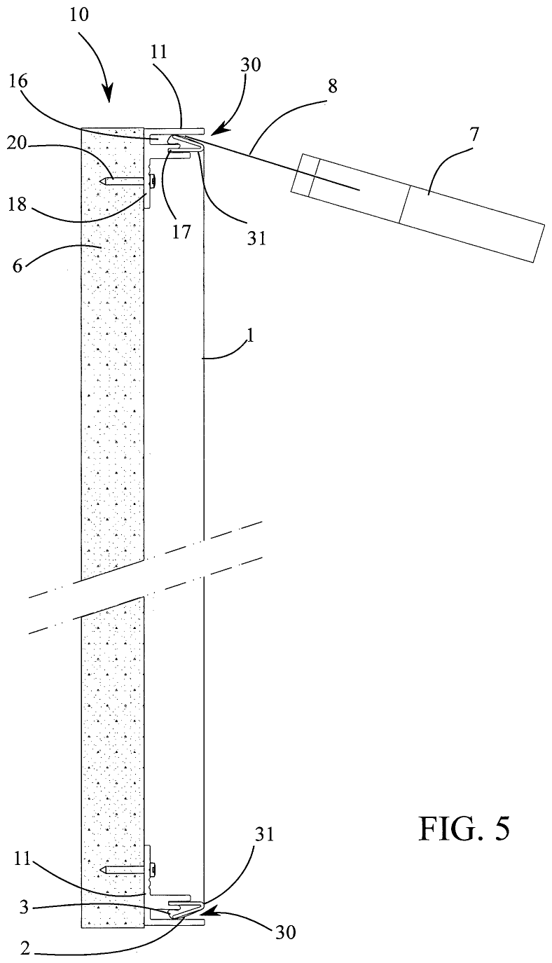

In the example shown, the base profile 11 comprises three longitudinal branches 12, 13, 14, which extend in parallel directions and which are connected by a bottom 15, namely an outer branch 12, an intermediate branch 13 and an inner branch 14. The terms relative to the outer leg and inner branch coincide with respect to said fixing frame 10 (FIGS. 5 and 6), and are the outer side of the frame not comprising a canvas and to the inner side of the frame comprising said canvas. These three branches extend more particularly in parallel planes and define between them two grooves 16, 17 longitudinal, open, substantially U-shaped. A first groove 16 is defined between the outer branch 12 and the intermediate branch 13 and forms a reception housing for a peripheral edge 2 of the canvas 1. It thus has a width L1, defined as being the distance between the outer branch 12 and the intermediate branch 13, and a depth P1 suitable for receiving the pinching system 30 and the peripheral edge 2 as well as the surplus 3 of said canvas 1. A second groove 17 is defined between the intermediate branch 13 and the inner branch 14 and forms an attachment zone for a holding profile 31. It thus has a width L2, defined as being the distance between the intermediate branch 13 and the outer branch 14, and a depth P2 adapted to the corresponding area of said holding profile 31. In the example illustrated, the width L1 of the first groove 16 is greater than the width L2 of the second groove 17, and the depth P1 of the first groove 16 is greater than the depth P2 of the second groove 17, the depths P1 and P2 being measured from the end of the outer branch 14. In other words, the length of the intermediate branch 13 on the side of the first groove 16 is greater than the length of the intermediate branch 13 on the side of the second groove 17. The distance L0 of the opening defined between the outer branch 12 and the inner branch 14 is equal to the sum of the widths 11 and 12 and the thickness of the intermediate branch 13. The length P0 of the outer branch 12 is preferably greater than the depths P1 and P2 of said grooves 16, 17. This outer branch 12 is longer than the other branches 13, 14 and is provided at least flush with the canvas 1 when it is mounted and tensioned on the fixing frame 10 (see FIGS. 5 and 6). This is because it constitutes the outer face of the fixing frame 10 when the latter is self-supporting according to FIG. 1 and contributes to the aesthetic appearance of the panel obtained. Of course, any other compatible arrangement and/or dimension of the branches 12, 13 and 14 and the grooves 16, 17 may be suitable.

The base profile 11 further comprises at least one fixing lug 18 which extends longitudinally and in the extension of the base 15, perpendicular to said branches 12, 13 and 14. This fixing lug 18 comprises perforations 19 distributed, preferably regularly, over the length of said profile for receiving fixing screws 20 for fixing the base profile 11 on a support wall 5 or on a frame 6 as illustrated in FIGS. 1 and 4. The base profile 11 also comprises, on said fixing tab 18, reinforcement grooves 21 participating in the stiffening of the profile, in particular in the direction of bending forces. Of course, the base profile 11 as illustrated may have a different cross-section while retaining its functionalities. It may in particular comprise an enlarged section integrating a base or the like, allowing it to be a self-supporting profile alone.

The clamping system 30 operates under compression constraint, that is to say that it is inserted on the base profile 11 while being under compression, so that the return force ensures both the holding of the clamping system 30 on the base profile 11 and the maintenance of the canvas 3 on the base profile 11.

In the following, the example in which the pinching system 30 comprises one, in practice, a plurality of holding profiles 31, which cooperate each with a base profile 11, a base profile 11 that can cooperate with a plurality of holding profiles 31.

The holding profile 31 used in the invention is illustrated more particularly in FIGS. 3, 5 and 6. It Is produced from an elongate, rectilinear, flexible part, preferably obtained by extrusion of a synthetic material, such as, for example, polyvinyl chloride (PVC) or any other equivalent material. In particular, the holding profile 31 comprises two longitudinal wings 32, 33, a first wing 32 and a second wing 33, which extend in parallel directions. These two wings 32, 33 are symmetrical or not, and assembled by a folding or bending zone 34 in order to form a V or a U, giving the holding profile 31 its properties of flexibility and elasticity.

More specifically, the holding profile 31 functions as a compression spring: in the absence of external constraint, the free end of the first wing 32 is at a distance from the free end of the second wing 33 by a determined initial value. When the two wings 32, 33 are brought together by exerting a compressive force, that is to say when the distance between the free ends of the two wings 32, 33 is reduced, the deformability and the elasticity of the folding zone involve a return force tending to return the distance between the free end two wings 32, 33 at its initial value.

Thus, when it is at rest, unused, in the absence of external constraint, in the so-called unlocked position, the holding profile 31 takes an open natural position in which the spacing E at the free end of its wings 32, 33 is greater than the width L0 of the opening delimited between the outer branch 12 and the inner branch 14 of said base profile 11 comprising the receiving housing. Of course, the holding profile 31 as illustrated may have a different cross-section while retaining its functionalities. FIG. 6 more particularly illustrates the operating principle of the pinching system 30. The latter is to be mounted in a base profile 11 before the canvas 1 is placed by maintaining it under compressive constraint between the outer branch 12 and the inner branch 4 of the base profile 11.

More specifically, according to the embodiment illustrated in FIG. 6, in which the clamping system 30 comprises the holding profile 31, to perform the mounting operation, the operator grasps the holding profile 31 of one hand or both hands according to the length thereof, overlaps the base profile 11 in such a way that the opening of the V faces the base profile 11, bringing the end of the first wing 32 against the outer branch 12 of the base profile 11 in a translational movement substantially perpendicular to the base 15 so as to bring the two wings 32, 33 together and reduce their spacing E, continuing its translational movement in order to fit the second wing 33 in the second groove 17 of the said base profile 11 as far as the bottom. The depth of the second groove 17 is defined so as to provide a free space between the bottom of the first groove 16 and the first wing 32 of the holding profile 31 in order to accommodate the surplus 3 of the canvas 1 freely therein. The height of the intermediate branch 13 of the base profile 11 is less than the two other but sufficient to ensure that the second wing 33 of the holding profile 31 is blocked without impeding its operation.

In this position, the first wing 32 is held under constraint in the first groove 16, and the second wing 33 is locked in position in the second groove 17 of the base profile 11. Thanks to the elasticity of the holding profile 31 under compression constraint, the wings 32, 33 exert opposing pressing forces against the outer 12 and inner 14 branches which thus ensure effective retention and clamping of the holding profile 31 secured to the base profile 11.

The mounting of the canvas 1 requires a traditional insertion tool 7, namely a flat blade tool 8, commonly known as a spatula, the shape of which is rather rounded so as not to injure the canvas 1. FIG. 5 illustrates the mode of insertion of the peripheral edge 2 of the canvas 1 into the base profile 11 by strongly inserting in order to overcome the pinching system 30, the blade 8 of the insertion tool 7 which accompanies said peripheral edge 2 in the first groove 16 between the outer branch 12 of the base profile 11 and the first wing 32 of the holding profile 31 as far as the bottom of said first groove 16. When the blade 8 of the insertion tool 7 is removed, the pinching system 30 returns to the initial position, that is to say that the first wing 32 of the holding profile 31 returns to contact with the external branch 12 and blocks by pinching the peripheral edge 2 of the canvas 1, the surplus 3 being housed and retained at the rear of this wing in the bottom of said first groove 16.

Removal of the canvas requires a protruding tab (not shown) of at least one of the peripheral edges 2 of the canvas 1, which remains outside the fixing frame 10 after mounting the canvas 1. When the operator wishes to replace the canvas 1 in order to change visual or to update it, it is sufficient to pull on the protruding tab in order to extract the peripheral edge 2 of the canvas 1 from the base profile 11 by performing a translational movement substantially perpendicular to the plane defined by said fixing frame 10. During this extraction movement, the surplus 3 of the canvas 1 stored in the bottom of the first groove 16 of the base profile 11, takes with it the holding profile 31, by unblocking its second wing 33 of the second groove 17 of the base profile 11. In fact, as the holding profile 31 is under compression constraint between the outer branch 12 and the inner branch 14 of the base profile 11, the extraction movement tends to separate the flanges 32, 33 of the holding profile 31, in the direction of the return force of the holding profile 31 under compression constraint. The removal of the holding profile 31 is facilitated. The free end of the first wing 32 can be rounded in order to further facilitate the removal of the holding profile 31 and further limit the risks of damaging the canvas 1.

Once a part of the canvas 1 has been released, it is sufficient to extract the rest of the peripheral edges 2 and the holding profiles 31 by hand.

The extraction of the canvas 1 and of the holding profile 31 is thus carried out by the extraction movement accompanied by the return force of the holding profile 31, so that the canvas 1 and the holding profile 31 are not damaged during the extraction and can both be reused. The costs of implementing the fixing frame 10 are thus reduced.

It clearly emerges from this description that the invention makes it possible to achieve the initial objectives, namely a system for quickly and easily assembling and disassembling a flexible canvas on a fixing frame, which is simple, safe, can be handled by any unskilled person, without damaging the canvas since it is held under tension in said fixing frame by means of the attached clamping system, between smooth, without relief, or notching surfaces.

The clamping system 30 operates under compressive constraint when it is inserted on the frame, between the outer branch 12 and the inner branch 14, and by the only return force, it simultaneously retains the canvas in the frame , by locking it against the outer branch 12, and its own retention on the frame. Only this return force must be overcome to extract both the clamping system 30 and the canvas 3 from the fixing frame 10.

The shape of the pinch system 30 can then be simple, no relief, no projection or no notching being required, so that it can easily be manufactured in a single step, for example of extrusion, reducing manufacturing costs.

The present invention dispenses entirely with specific features on the canvas 3. In particular, it is not necessary to set up means for stiffening one or more edges.

The present invention is not limited to the embodiments described but extends to any modification and variant obvious to a person skilled in the art.

1-20. (canceled)

21. A method of mounting a flexible canvas stretched over a fixing frame, wherein the fixing frame comprises an assembly of rigid base profiles, each base profile comprising a first longitudinal groove constituting a receiving housing for a peripheral edge of the covering, and comprising an outer branch and an inner branch, and, before mounting the canvas on the fixing frame, a clamping system is added to each base profile, the method comprising:
inserting the clamping system under compressive constraint between the outer branch and the inner branch of the base profile, the clamping system being arranged to retain the peripheral edge in the receiving housing, and the clamping system being removable and comprising at least one distinct and separate part of the base profiles and the canvas, and
in order to mount the canvas on the fixing frame, using an insertion tool to introduce the peripheral edge of the canvas into the receiving housing against the compression of the clamping system.

22. The mounting method according to claim 21, wherein to achieve the clamping system, use is made of profiles for maintaining, each profile for holding comprising a first wing and a second wing extending in two directions, the first wing of the holding profile engaging with the outer branch of the base profile and the second wing of the retaining section engaging with the inner branch of the base section.

23. The mounting method according to claim 21, wherein, to achieve the clamping system, one uses flexible holding profiles and fits the at least one holding profile on each base profile, the holding profile comprise at least a first wing which is inserted under constraint into the receiving housing so that the first wing cooperates with a fixed branch of the base profile and clamps the canvas.

24. The mounting method according to claim 22, wherein one uses a base profile provided with a second longitudinal groove extending in a direction parallel to that of the first groove, and a holding profile is used comprising a first wing and a second wing extending in two directions, the first wing cooperates with the first groove to form the clamping system, and the second wing is fitted into the second groove of the base profile to create a fixed but removable connection of the holding profile.

25. The mounting method according to claim 23, wherein a holding profile has one of a V-shaped or a U-shaped section.

26. The mounting method according to claim 21, wherein a protruding tab, on at least one of its peripheral edges, is provided on the flexible canvas, this tab is arranged to remain accessible outside the fixing frame after mounting the canvas, and to remove the canvas from the fixing frame, the tab is pulled to extract the corresponding peripheral edge of the base profile, taking with it the corresponding holding profile which disengages from the base profile to enable the canvas to be removed.

27. The mounting method according to claim 21, wherein the base profiles are assembled together to create an autonomous and self-supporting fixing frame.

28. The mounting method according to claim 21, wherein each base section is assembled end-to-end on a frame to create a fixing frame with an autonomous and self-supporting frame.

29. The assembly method according to claim 21, wherein each base section is assembled end-to-end on a support wall to create a fixing frame superimposed on the support wall.

30. The mounting method according to claim 21, wherein the canvas has no stiffened edge.

31. A fixing frame, for the implementation of the mounting method according to claim 21, wherein the fixing frame comprises an assembly of rigid base profiles, each base profile comprising a first groove constituting a receiving housing for a peripheral edge of the canvas and comprising an outer branch and an inner branch, wherein the frame comprises in addition a clamping system attached directly to each base section, arranged to be inserted under compressive constraint between the outer branch and the inner branch of the base section, and arranged to retain the peripheral edge in the receiving housing during assembly of the canvas, the clamping system is removable and comprises at least one part separate from the base profiles and the canvas.

32. The fixing frame according to claim 31, wherein the clamping system comprises sections for maintaining, and each section for maintaining comprises a first wing and a second wing which extend in two directions parallel to each other, the first wing of the holding profile engages with the outer branch of the base profile and the second wing of the profile support engages with contact with the inner branch of the base profile.

33. The fixing frame according to claim 31, wherein the clamping system comprises flexible holding profiles, at least one holding profile is fitted onto each base profile, and the holding profile comprises at least a first wing inserted under stress in the receiving housing so that the first wing cooperates with a fixed branch of the base profile and forms, with the first wing, the clamping system.

34. The fixing frame according to claim 31, wherein the base profile comprises a second longitudinal groove extending in a direction parallel to that of the first groove, and the holding profile comprises a first wing and a second wing extending in two different directions, the first wing cooperates with the first groove for clamping the canvas, and the second wing is fitted into the second groove of the base profile to create a fixed but removable connection of the holding profile.

35. The fixing frame according to claim 32, wherein the holding profile has one of a V-shaped or U-shaped section.

36. The fixing frame according to claim 34, wherein the first groove and the second groove of the base profile are parallel to one another.

37. The fixing frame according to claim 36, wherein the second groove of the base profile has a depth less than that of the first groove.

38. The fixing frame according to claim 34, wherein the second groove of the base profile has a width less than that of the first groove.

39. The fixing frame according to claim 31, wherein the fixing frame comprises an assembly device for assembling the base profiles between them and creating an autonomous and self-supporting fixing frame.

40. The fixing frame according to claim 31, wherein the base profiles further comprise a longitudinally extending fixing lug allowing them to be fixed to a support wall or a frame.
